(19) United States
(12) Patent Application Publication
(10) Pub. No.: US 2026/0134335 A1
(43) Pub. Date: May 14, 2026

(54) TRAINING MACHINE-LEARNING MODEL OF AN ONLINE SYSTEM TO DETERMINE A LEVEL OF MATCHING BETWEEN IDENTIFIERS OF ITEMS STORED IN A DATABASE OF ONLINE SYSTEM

(71) Applicant: Maplebear Inc., San Francisco, CA (US)

(72) Inventor: Naval Shah, Toronto (CA)

(21) Appl. No.: 18/943,720

(22) Filed: Nov. 11, 2024

(51) Int. Cl. G06N 20/00

(52) U.S. Cl. CPC G06N 20/00

(57) ABSTRACT

An online system trains a machine-learning model to identify a level of matching (equivalency or similarity) between item identifiers (e.g., brands) stored in a database. The online system receives search data including information about a search query including a series of identifiers. The online system further receives conversion data including information about a search query in relation to a first identifier that is followed by conversion of an item having a second identifier. The online system further receives communication data exchanged between a servicing agent and a user with information about a message including identifiers of items. The online system generates, based on the search data, the conversion data, and/or the communication data, training data for the machine-learning model. The online system trains, using the training data, the machine-learning model to identify the level of matching between an identifier searched for by a user and a replacement identifier.

### BACKGROUND

Online systems allow their users to browse and acquire items of various categories or identifiers (e.g., brands). For example, when a user of an online system has a preference about a certain brand, the online system may need to find a replacement one, such as when an item of the preferred brand is unavailable. Thus, it is desirable for the online system to be able to identify, for a given target brand, what other brands are similar to the target brand. For example, for search results when a searched-for brand is unavailable, it is desirable for the online system to show its users a brand that is the most similar to the explicitly searched-for brand. However, there is a technical problem of how to identify, in an automatic manner and at a large scale as required by the online system, what brand or cohort of brands is the most similar to an explicitly searched-for brand.

### SUMMARY

Embodiments of the present disclosure are directed to training a machine-learning model of an online system to determine a level of matching (e.g., equivalency or similarity) between identifiers (e.g., brands) of items stored in an item database of the online system.

In accordance with one or more aspects of the disclosure, the online system receives, via a network from a first device associated with a first user of the online system, search data including information about a series of search queries entered by the first user via a user interface of the first device, the series of search queries including a series of identifiers for a set of items. The online system generates a search query label indicating matching of the series of identifiers. The online system receives, via the network from a second device associated with a second user of the online system, conversion data including information about a search query entered by the second user via a user interface of the second device in relation to a first identifier of a first item that is followed by conversion by the second user of a second item having a second identifier different from the first identifier. The online system generates a conversion label indicating matching of the first identifier and the second identifier. The online system receives, via the network from at least one of a device of a servicing agent associated with the online system or a third device associated with a third user of the online system, communication data exchanged between the device of the servicing agent and the third device with information about a message including a plurality of identifiers of a plurality of items. The online system generates a chat label indicating matching of the plurality of identifiers. The online system generates training data for an identifier matching machine-learning model of the online system by including in the training data a label comprising at least one of the search query label, the conversion label, or the chat label. The online system trains, using the training data, the identifier matching machine-learning model to generate a set of initial values for a set of parameters of the identifier matching machine-learning model, wherein the identifier matching machine-learning model is trained using the training data including the label to identify a level of matching between an identifier searched for by a user of the online system via a user interface of a device associated with the user and a replacement identifier, the label representing a ground truth for the level of matching between the identifier and the replacement identifier. The online system applies the identifier matching machine-learning model to information about the identifier and information about the replacement identifier to generate a matching score indicating the level of matching between the identifier and the replacement identifier that is indicative of whether the replacement identifier is a valid replacement for the identifier.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates an example architectural flow diagram of training and using a trained machine-learning model of an online system to determine a level of matching between item identifiers (e.g., brands) stored in an item database of the online system, in accordance with one or more embodiments.

FIG. 4 is a flowchart for a method of training a machine-learning model of an online system to determine a level of matching between item identifiers (e.g., brands) stored in an item database of the online system, in accordance with one or more embodiments.

### DETAILED DESCRIPTION

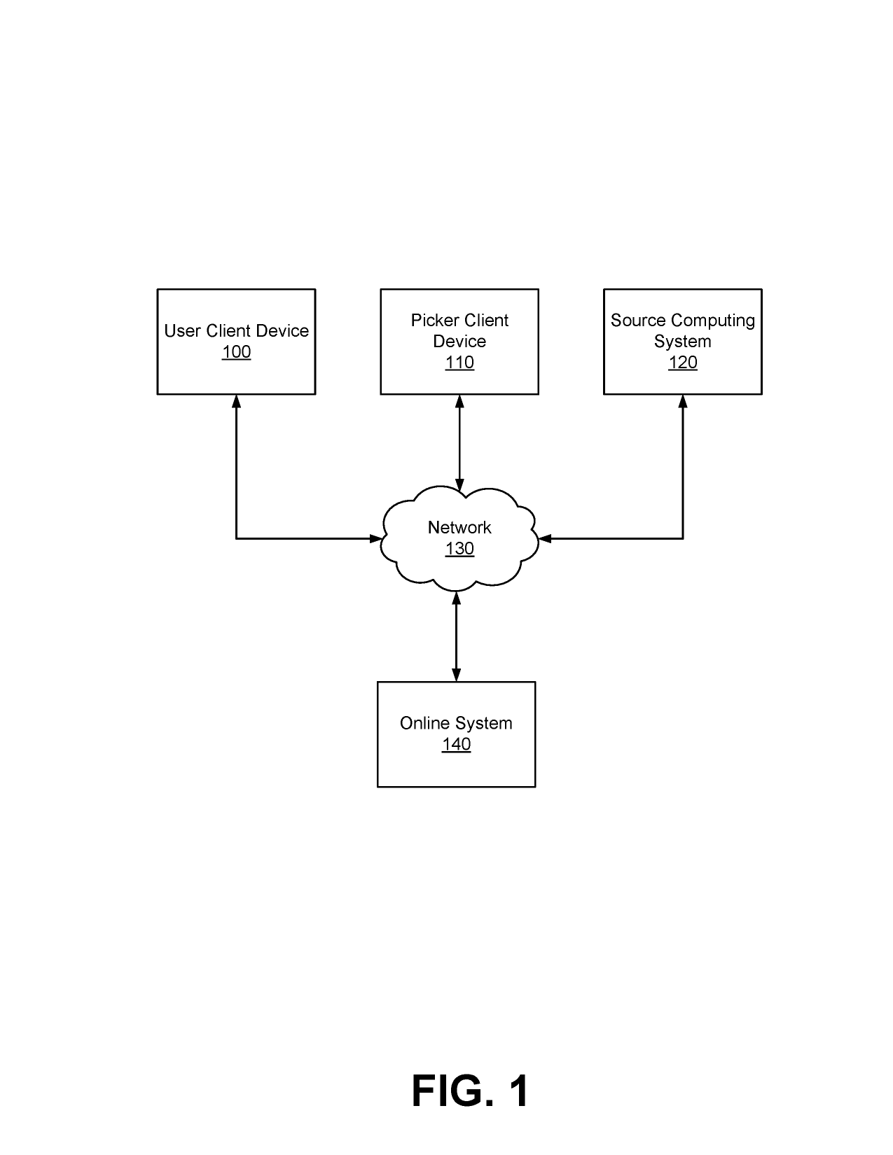

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker (i.e., fulfillment agent, servicing agent, or agent) that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user’s order to the picker in a collection interface. The collection interface is a user interface that provides information to the picker on which items to collect for a user’s order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user’s order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. Patent Application No. 18/630,672, entitled “Automated Identification of Items Placed in a Cart and Recommendations based on Same,” filed April 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user’s order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user’s order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a source location. The user’s order may specify which groceries they want to be delivered from the source location and the quantities of each of the groceries. The user client device 100 transmits the user’s order to the online system 140 and the online system 140 selects a picker to travel to the source location to collect the groceries ordered by the user. The online system transmits an offer to the picker for the picker to service the order in exchange for consideration and, if the picker accepts the offer, the picker collects the groceries from the source location. Once the picker has collected the groceries ordered by the user, the picker delivers the groceries to a location transmitted to the picker client device 110 by the online system 140.

The online system 140 enables users to browse and acquire items associated with different brands, and occasionally when an item of one brand is unavailable, the online system 140 may suggest an item of a different brand. To determine similar or comparable brands, the online system 140 trains a machine-learning model to provide a score (e.g., similarity score or matching score) identifying a level of matching (i.e., similarity or equivalency) between a target brand (i.e., originally requested brand) and a candidate replacement brand. The online system 140 with the trained machine-learning model presented herein is configured to identify, for a given target brand, a set of most equivalent brands to the target brand. Thus, when a user of the online system 140 requests an item of a specific brand that is unavailable, the online system 140 runs the trained machine-learning model and provides, as an output, information about what are the next most preferred brand options.

The online system 140 may apply a machine-learning algorithm of the trained machine-learning model to a set of inputs to identify one or more replacement brands (or one or more alternative brands) for the target brand. The set of inputs provided to the machine-learning model may be replacement data, search history, third party data inputs, picker-user chats, etc. The online system 140 may obtain labels used for training of the machine-learning model from previous interactions with the online system 140 involving brands, such as when users of the online system 140 search for one brand and then select another brand if the originally searched-for brand is unavailable.

There are various instances of users’ sessions at the online system 140 where a brand is either explicitly chosen by a user of the online system 140 (e.g., during an online shopping where the user can filter items by brand), or implicitly when a user of the online system 140 chooses a specific branded item. In many of these instances, the online system 140 may need to choose a next preferred option for a brand, such as when a brand that is requested (e.g., either explicitly or implicitly) is not available either due to being out-of-stock or because the requested brand is not in an inventory of a source the user is shopping at. Having the online system 140 capable of identifying a brand matching (or equivalency) ranking may facilitate users’ online conversion sessions as the users would be presented with more relevant options in relation to branded items.

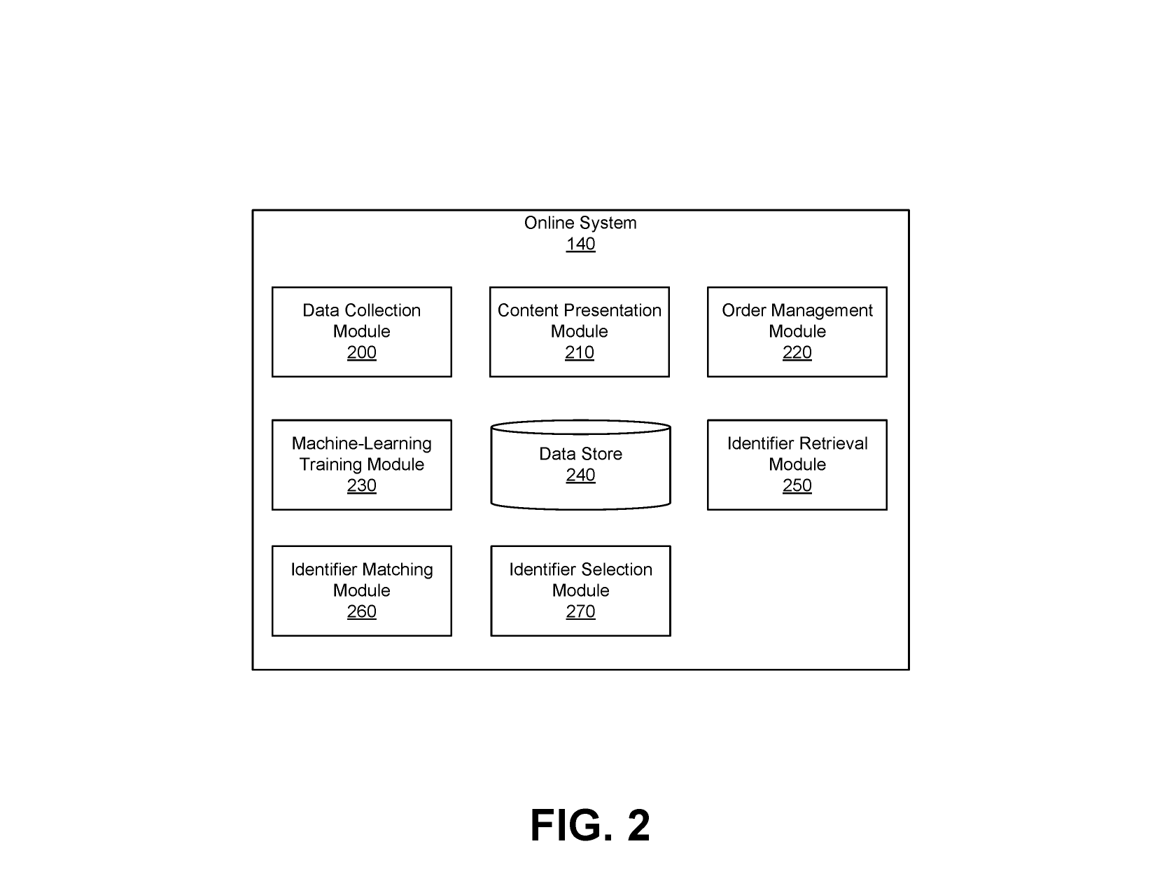

The identification of similar or comparable brands may also be utilized to generate a set of cohort brands for use in reporting insights to a particular brand owner. Similarly, consumer packaged goods (CPG) entities would like to understand how their return on ad spend (ROAS) for specific brands compares with their peer group of CPG entities. However, it may not be known who exactly is in a peer group for a specific brand of a CPG entity. The online system 140 with the trained machine-learning model presented herein allows accurate identification of a peer group for a specific CPG’s brand, which can be used to provide CPG entities associated with the online system 140 with better general insights about their brands, as well as in the context of their ad campaigns’ ROAS. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, an identifier retrieval module 250, an identifier matching module 260, and an identifier selection module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user’s name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user’s interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online system 140, a user rating for the picker, which sources the picker has collected items at, or the picker’s previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker’s interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker’s performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker’s location and the location of the source from which the ordered items are to be collected. The order management module 220 may also offer an order to a picker based on how many items are in the order, a vehicle operated by the picker, the delivery location, the picker’s preferences on how far to travel to deliver an order, the picker’s ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker’s current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user’s order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

A user of the online system 140 may utilize a search interface of the user client device 100 to explicitly identify a target brand. Alternatively, a user of the online system 140 may implicitly identify a target brand by requesting a corresponding branded item. A target brand can be also referred to herein as a target identifier that identifies an item or a group of items. The user’s identification of the target brand at the online system 140 may trigger operations of the identifier retrieval module 250 that retrieves, from a database (e.g., part of the data store 240) a set of candidate brands (or set of candidate identifiers) for replacement of the target brand. In one or more embodiments, when a requested target brand is not available at a source associated with the online system 140 or an item of the target brand is unavailable, the identifier retrieval module 250 identifies the set of candidate brands by retrieving, from the database, a defined number of most preferred brands that are historically used for replacing the unavailable target brand or the unavailable item of the target brand. In one or more other embodiments, when the online system 140 measures peer groups of a CPG entity, the identifier retrieval module 250 identifies a set of candidate brands for a CPG’s brand by aggregating most preferred brands for replacing the CPG’s brand across all items that belong to the peer groups.

The identifier matching module 260 may access an identifier matching model (e.g., machine-learning model) that is trained to identify a level of matching (i.e., level of equivalency, or level of similarity) between each candidate brand from the set of candidate brands and the target brand. The identifier matching module 260 may deploy the identifier matching model to run a machine-learning algorithm to output, based on input signals, a matching score for each candidate brand that identifies (i.e., measures) the level of matching between each candidate brand and the target brand. The matching score may be a value between 0 and 1, where a lower value of the matching score may indicate a lower level of matching (equivalency or similarity) between a corresponding candidate brand and the target brand, and a higher value of the matching score may indicate a higher level of matching between a corresponding candidate brand and the target brand. A set of parameters for the identifier matching model may be stored at one or more non-transitory computer-readable media of the identifier matching module 260. Alternatively, the set of parameters for the identifier matching model may be stored at one or more non-transitory computer-readable media of the data store 240.

The identifier matching module 260 may provide the input signals to the identifier matching model. In providing the input signals to the identifier matching model, the identifier matching module 260 may provide features for the target brand and features for each candidate brand. The identifier matching module 260 may retrieve the features for the target brand and the features for each candidate brand from the data store 240.

The machine-learning training module 230 may perform initial training of the identifier matching model using training data. The machine-learning training module 230 may generate the training data based on historical brand searches, explicit labels from users of the online system, historical replacements selections, chats between users of the online system 140 and pickers associated with the online system 140, some other training datasets, or some combination thereof. The machine-learning training module 230 may train the identifier matching model using the training data to generate initial values for the set of parameters of the identifier matching model.

In one or more embodiments, the machine-learning training module 230 generates the training data by collecting co-occurrences of brands in user search history when users of the online system 140 issue a sequence of item searches, such as one after another. For example, a user of the online system 140 may first search for the “Brand A Root Beer” (e.g., via a search interface of the user client device 100), which is followed by another search for “Brand B Root Beer”. Alternatively or additionally, the machine-learning training module 230 may generate the training data based on a user’s request for an item of one brand (e.g., via a user interface of the user client device 100) and subsequent conversion of an item of a different brand (e.g., when an item of the searched-for brand was unavailable). Information about these kinds of brand searching may be captured in real time from the user client devices 100 and stored in a user catalog database (e.g., at the data store 240), e.g., for later retrieval as the training data by the machine-learning training module 230.

In one or more other embodiments, the machine-learning training module 230 generates the training data based on explicit labels from users of the online system 140. The explicit labels for a specific brand may be collected when the specific brand is unavailable, and the online system 140 asks the users, via user interfaces of the user client devices 100, to select alternative brands. The responses from the users may be recorded at the user client devices 100 and stored as corresponding brand labels at a brand catalog database (e.g., at the data store 240), e.g., for later retrieval as the training data by the machine-learning training module 230.

In one or more other embodiments, the machine-learning training module 230 generates the training data based on historical replacement selections conducted by users of the online system 140. For example, when an item of a specific brand that is requested by a user of the online system 140 is unavailable, the user selects a replacement item of a different brand. This replacement data may be recorded at the user client device 100 and stored as item replacement data at an item catalog database (e.g., at the data store 240), e.g., for later retrieval as the training data by the machine-learning training module 230.

In one or more other embodiments, the machine-learning training module 230 generates the training data by collecting data received via application programming interfaces (APIs) of the online system 140 that are exposed to third party entities (e.g., as part of an online platform) when the APIs take explicit inputs for brands. Alternatively or additionally, the machine-learning training module 230 may generate the training data based on search data entered via a user interface of the online system 140 having an explicit ‘advanced search’ user interface element that allows a brand to be a wholly separate input from a search query. In such cases, information may be recorded about what is the explicit brand that a user of the online system 140 selected, as well as information about whether the user’s explicit brand selection resulted in an item of that brand being included into a final conversion cart. The recorded information about explicit brand selections and conversions of corresponding items may be received from user client devices 100 over time and stored in a brand catalog database (e.g., at the data store 240), e.g., for later retrieval as the training data by the machine-learning training module 230.

In one or more other embodiments, the machine-learning training module 230 generates the training data by collecting information about chats between pickers associated with the online system 140 and users of the online system 140, e.g., when a user of the online system 140 is specifying multiple brands in one message sent from the user client device 100 to the picker client device 110. This may happen when the user asks for an item that is relatively new and unknown, or when the user is messaging about an item replacement and specifies a number of brands that are viable options. The picker-user chat data may be received at the online system 140 from picker client devices 110 and/or user client devices 100 and stored at a chat database (e.g., at the data store 240), e.g., for later retrieval as the training data by the machine-learning training module 230.

The identifier selection module 270 may select one or more brands from the set of candidate brands as replacement brands for the target brand (e.g., for recommendation to a user of the online system 140). The identifier selection module 270 may select the one or more brands based on their matching scores output by the identifier matching model. The identifier selection module 270 may first rank candidate brands from the set of candidate brands based on their matching scores. After that, the identifier selection module 270 may select the one or more brands that either represent a brand with the highest matching score among all candidate brands in the set of candidate brands, or a defined number of brands having the highest matching scores among the set of candidate brands. In one or more embodiments, based on information about the selected one or more brands for replacing the target brand, the content presentation module 210 generates a user interface of the user client device 100 that displays one or more items of the selected one or more brands recommended to the user for conversion.

The machine-learning training module 230 may collect feedback data with information about an engagement by the user in relation to one or more brands suggested for replacement of the target brand. The engagement may be conversion by the user of an item of a replacement brand, viewing details about suggested replacement brands and corresponding items without preforming any conversion, ignoring all suggested replacement brands, etc. The information about the user’s engagement may be recorded at the user client device 100 and communicated, via the network 130, to the online system 140 and the machine-learning training module 230 as the feedback data. The machine-learning training module 230 may then re-train the identifier matching model by updating the set of parameters of the identifier matching model using the feedback data.

The online system 140 may apply the identifier matching model for determination of brand matching (i.e., brand equivalency, or brand similarity) for several practical usages. First, the online system 140 may apply the determination of brand matching for both automated and manual ad campaigns. In particular, the brand matching may inform the online system 140 (as well as a source associated with the online system 140) where to surface ads or recommendations for ads. For example, a CPG entity can set up ad campaigns both manually and automatically. For a manual ad campaign, the CPG entity may specify tags (e.g., keywords) that are desired to match (e.g., keyword bids). The online system 140 may apply the determination of brand matching presented herein to recommend keywords to the CPG entity based on identified matching of brands. Similarly, for an automated ad campaign, the online system 140 may leverage the determination of brand matching presented herein to identify where to insert ads and what keywords and equivalent brands to match.

Second, the online system 140 may apply the determination of brand matching in the case of having a user interface of the online system 140 with an explicit search filter for brand that represents an explicit ingredient match input. In such cases, a user of the online system 140 may specify, via a search interface of the user client device 100, a brand in a query, but the brand of the searched-for item is unavailable. Then, the online system 140 may apply the determination of brand matching to generate search results with one or more items of alternative brand(s) recommended to the user.

In one or more embodiments, a user interface of the online system 140 includes an explicit brand input. For example, the explicit brand input may be available at search APIs (e.g., search for an item, and brand is explicit input). Alternatively or additionally, the explicit brand input may be available at a user interface with ingredient matching inputs (e.g., recipe landing page, where a set of recipe ingredients is matched to items). When users of the online system 140 (or third-party entities associated with the online system 140) utilize the explicit brand input for browsing available items and the originally selected brand is not available, the online system 140 may apply the determination of brand matching to generate search results with alternative brands offered for conversion. For example, if a user of the online system 140 (or a third-party entity associated with the online system 140) explicitly asked for dishwasher pods of Brand A and those are unavailable in a region or out of stock, the online system 140 may apply the determination of brand matching to identify Brand B as a brand having sufficient level of matching (i.e., equivalency or similarity) with the search-for Brand A, and then try to find items of Brand B (e.g., dishwasher pods) that will match the user’s expectations.

Third, the online system 140 may apply the determination of brand matching for the purpose of providing insights about brands to CPG entities, including ROAS comparisons. In such cases, the online system 140 may apply the determination of brand matching to define a peer group for a specific brand of a CPG entity, and then provide insights about how the specific brand of the CPG entity is performing relative to brands of its peer group. Alternatively or additionally, the online system 140 may apply the determination of brand matching in the case of CPG’s ad campaigns to compare their ROAS to their peer group. In such cases, the online system 140 may provide valuable information to the CPG entity about how similar brands are performing with their ad campaigns, which may help the CPG entity improve their ad content or change other characteristics that may be problematic or holding back ROAS.

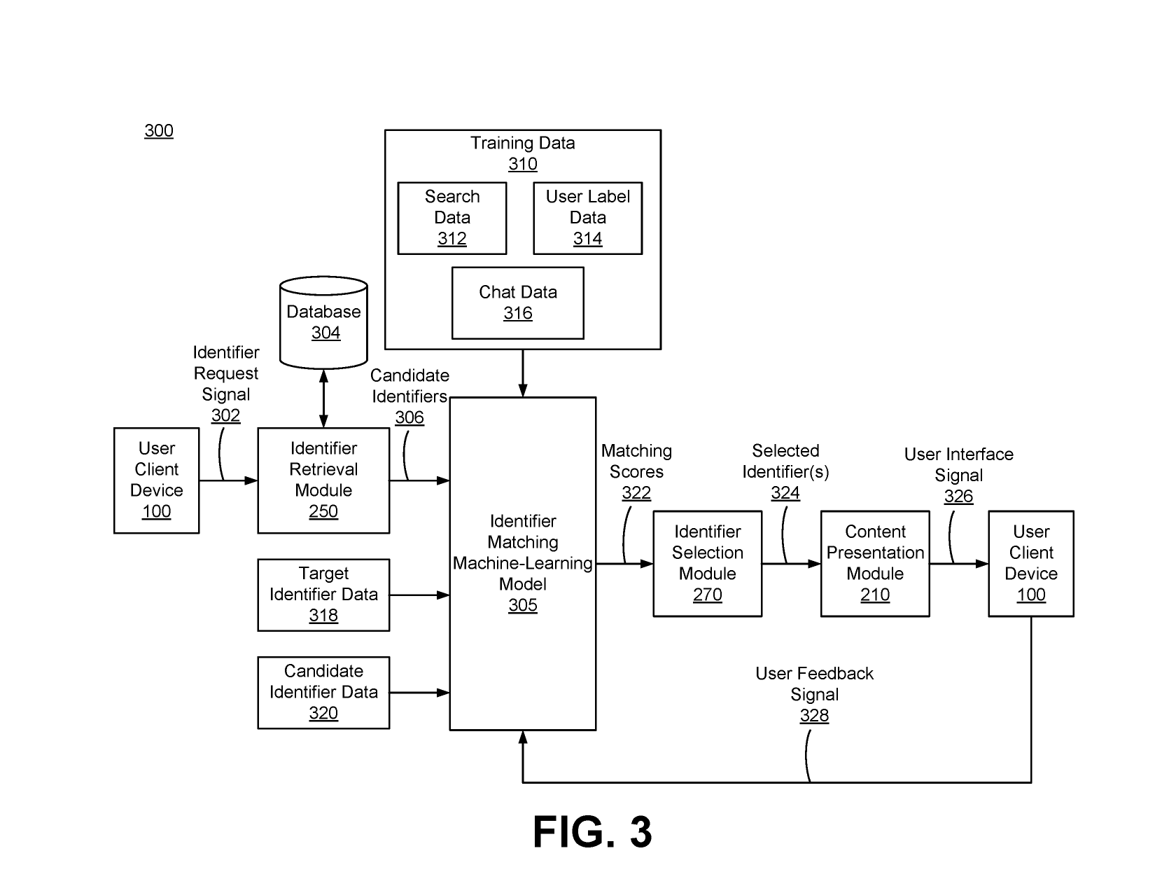

FIG. 3 illustrates an example architectural flow diagram 300 of training and using an identifier matching machine-learning model 305 of the online system 140 to determine a level of matching (or equivalency) between item identifiers (e.g., brands) stored in an item database of the online system, in accordance with one or more embodiments. The process flow may be initiated by the identifier retrieval module 250 upon receiving an identifier request signal 302 from the user client device 100 via the network 130. The identifier request signal 302 may be generated when a user of the online system 140 engages with a user interface of the user client device 100 and requests an item of a target identifier (e.g., target brand) that is unavailable at a source associated with the online system 140 or explicitly requests a target item identifier (e.g., target brand) that is unavailable at the source.

Responsive to the reception of the identifier request signal 302 that includes information about the target identifier requested by the user, the identifier retrieval module 250 may retrieve, from a database 304 (e.g., the data store 240), a set of candidate identifiers 306 (e.g., set of candidate brands) as possible alternatives for the target identifier. The identifier retrieval module 250 may generate the set of candidate identifiers 306 by retrieving, from the database 304, a defined number of most preferred identifiers that are historically used for replacing the unavailable target identifier or the unavailable item having the target identifier. The identifier retrieval module 250 may pass information about each candidate identifier from the set of candidate identifiers 306 to the identifier matching machine-learning model 305.

Prior to running a machine-learning algorithm of the identifier matching machine-learning model 305, the online system 140 may perform (e.g., via the machine-learning training module 230) initial training of the identifier matching machine-learning model 305 using training data 310 to generate initial values for a set of parameters of the identifier matching machine-learning model 305. The training data 310 may be generated (e.g., via the machine-learning training module 230) from multiple sources, such as from search data 312, user label data 314, and/or chat data 316.

The search data 312 may include information about co-occurrences of identifiers (e.g., brands) in user search history when users of the online system 140 enter a sequence of item searches with multiple identifiers, such as one after another. The search data 312 may further include information about a user’s request for an item of one identifier (e.g., brand) that is followed by user’s conversion of an item of a different identifier (e.g., when an item of the searched-for identifier was unavailable). The search data 312 may be captured in real time from the user client devices 100 and stored in a user catalog database (e.g., at the data store 240) to be later retrieved by the machine-learning training module 230 as at least part of the training data 310.

The user label data 314 may include information about explicit labels obtained from users of the online system 140 for specific identifiers (e.g., brands). The user label data 314 may be collected when items of the specific identifiers are unavailable, and the online system 140 asks the users, via user interfaces of the user client devices 100, to select alternative identifiers (e.g., alternative brands). The responses from the users may be recorded at the user client devices 100 and stored as the user label data 314 in an identifier database (e.g., part of the data store 240) to be later retrieved by the machine-learning training module 230 as at least part of the training data 310.

The chat data 316 may include information about chats between pickers associated with the online system 140 and users of the online system 140, such as, when a user of the online system 140 is specifying multiple identifiers (e.g., brands) in a single message sent from the user client device 100 to the picker client device 110. The chat data 316 may include information about users messaging about item replacements and specifying a list of identifiers that are viable options for replacing an originally requested identifier (e.g., target brand). The chat data 316 may be received at the online system 140 from picker client devices 110 and/or user client devices 100 via the network 130 and stored in a chat database (e.g., part of the data store 240) to be later retrieved by the machine-learning training module 230 as at least part of the training data 310.

After training of the identifier matching machine-learning model 305 using the training data 310 is completed, the online system 140 may provide a set of inputs to the identifier matching machine-learning model 305 (e.g., via the identifier matching module 260), such as target identifier data 318 and candidate identifier data 320. Some additional inputs not shown in FIG. 3 suitable for identifying a level of matching (i.e., level of equivalency, or level of similarity) between each candidate identifier from the set of candidate identifiers 306 and the target identifier may be further provided to the identifier matching machine-learning model 305.

In providing the set of inputs to the identifier matching machine-learning model 305, the identifier matching module 260 may provide the target identifier data 318 with information about features of the target identifier, and the candidate identifier data 320 with information about features of each candidate identifier from the set of candidate identifiers 306. The identifier matching module 260 may retrieve the target identifier data 318 and the candidate identifier data 320 from the identifier database (e.g., the data store 240).

The identifier matching machine-learning model 305 may apply, for each candidate identifier from the set of candidate identifiers 306, the machine-learning algorithm to output a matching score 322 (e.g., value between 0 and 1) that indicates a level of matching (i.e., level of equivalency, or level of similarity) between each candidate identifier from the set of candidate identifiers 306 and the target identifier. The identifier matching machine-learning model 305 may pass the matching score 322 for each candidate identifier from the set of candidate identifiers 306 to the identifier selection module 270.

The identifier selection module 270 may select, based on the matching score 322 for each candidate identifier from the set of candidate identifiers 306, one or more identifiers 324 (e.g., alternative brands) from the set of candidate identifiers 306. The identifier selection module 270 may first rank candidate identifiers from the set of candidate identifiers 306 based on their matching scores 322. After that, the identifier selection module 270 may select the one or more identifiers 324 that either represent an identifier with a highest matching score among all matching scores 322, or a defined number of identifiers having highest matching scores among all matching scores 322. The identifier selection module 270 may pass information about the one or more selected identifiers 324 to the content presentation module 210.

Based on the information about the one or more selected identifiers 324, the content presentation module 210 may generate a user interface signal 326 and communicates, via the network 130, the user interface signal 326 to the user client device 100. The user interface signal 326 may display, at a user interface of the user client device 100, one or more items having the one or more selected identifiers 324 (e.g., one or more items of alternative brands). The user client device 100 may generate and record a user feedback signal 328 with information about an engagement by the user with the one or more items having the one or more selected identifiers 324. The engagement may be conversion of any of the one or more items, viewing details about the one or more items without conducting conversion, or fully ignoring the one or more items displayed at the user interface of the user client device 100.

The online system 140 may receive (e.g., via the machine-learning training module 230) the user feedback signal 328 from the user client device 100 via the network 130. The machine-learning training module 230 may utilize the user feedback signal 328 to re-train the identifier matching machine-learning model 305. By utilizing user feedback signals 328 from different users of the online system 140, the machine-learning training module 230 may continuously update the set of parameters of the identifier matching machine-learning model 305 and continuously improve the machine-learning algorithm of the identifier matching machine-learning model 305.

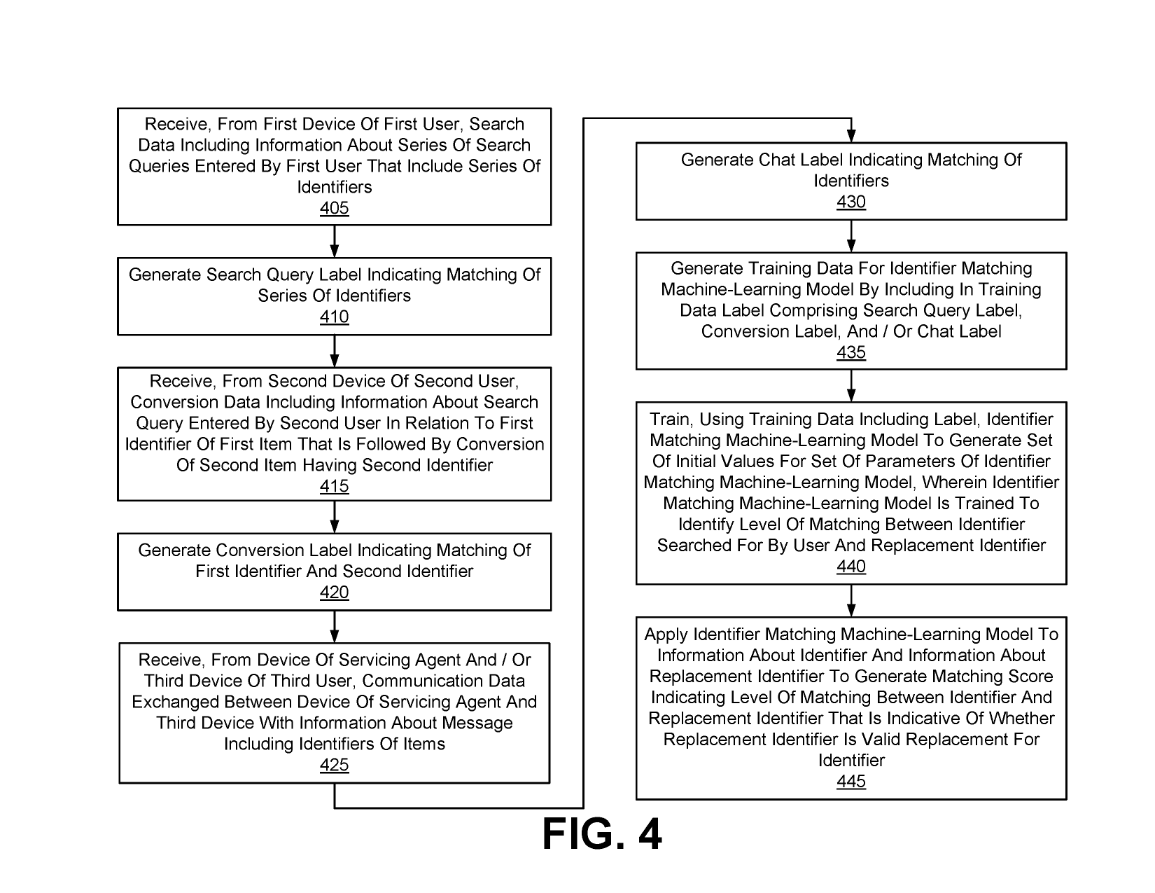

FIG. 4 is a flowchart for a method of training a machine-learning model of an online system to determine a level of matching (or equivalency) between item identifiers (e.g., brands) stored in an item database of the online system, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., the online system 140). Additionally, each of these steps may be performed automatically by the online system without human intervention.

The online system 140 receives 405 (e.g., at the order management module 220), via a network (e.g., the network 130) from a first device associated with a first user of the online system 140 (e.g., the user client device 100), search data including information about a series of search queries entered by the first user via a user interface of the first device, the series of search queries including a series of identifiers (e.g., brands) for a set of items. The online system 140 generates 410 (e.g., via the machine-learning training module 230) a search query label indicating matching of the series of identifiers.

The online system 140 receives 415 (e.g., at the order management module 220), via the network from a second device associated with a second user of the online system 140 (e.g., the user client device 100), conversion data including information about a search query entered by the second user via a user interface of the second device in relation to a first identifier of a first item that is followed by conversion by the second user of a second item having a second identifier different from the first identifier. The online system 140 generates 420 (e.g., via the machine-learning training module 230) a conversion label indicating matching of the first identifier and the second identifier.

The online system 140 receives 425 (e.g., at the order management module 220), via the network from at least one of a device of a servicing agent associated with the online system 140 (e.g., the picker client device 110) or a third device associated with a third user of the online system 140 (e.g., the user client device 100), communication data exchanged between the device of the servicing agent and the third device with information about a message including a plurality of identifiers of a plurality of items. The online system 140 generates 430 (e.g., via the machine-learning training module 230) a chat label indicating matching of the plurality of identifiers.

The online system 140 generates 435 (e.g., via the machine-learning training module 230) training data for an identifier matching machine-learning model of the online system by including in the training data a label comprising at least one of the search query label, the conversion label, or the chat label. The online system 140 trains 440 (e.g., via the machine-learning training module 230), using the training data including the label, the identifier matching machine-learning model to generate a set of initial values for a set of parameters of the identifier matching machine-learning model, wherein the identifier matching machine-learning model is trained to identify a level of matching between an identifier searched for by a user of the online system via a user interface of a device associated with the user and a replacement identifier, the label representing a ground truth for the level of matching between the identifier and the replacement identifier. The online system 140 applies 445 the identifier matching machine-learning model (e.g., via the identifier matching module 260) to information about the identifier and information about the replacement identifier to generate a matching score indicating the level of matching between the identifier and the replacement identifier that is indicative of whether the replacement identifier is a valid replacement for the identifier, i.e., whether the replacement identifier is user-preferred identifier for replacing the searched-for identifier.

The online system 140 may send (e.g., via the content presentation module 210), via the network to a group of devices associated with a group of users of the online system 140, communications prompting each user from the group of users to select an alternative identifier to replace a target identifier requested by the group of users. The online system 140 may receive (e.g., at the data collection module 200), via the network from the group of devices, label data including information about a response from each user from the group of users about selection of the alternative identifier. The online system 140 may generate (e.g., via the machine-learning training module 230), further based on the label data, the training data for the identifier matching machine-learning model.

The online system 140 may receive (e.g., at the order management module 220), via the network from a fourth device associated with a fourth user of the online system 140 (e.g., the user client device 100), replacement data including information about a conversion by the fourth user of a third item having a third identifier instead of a fourth item having a fourth identifier different from the third identifier, the fourth item being unavailable in a location of a source associated with the online system 140. The online system 140 may generate (e.g., via the machine-learning training module 230), further based on the replacement data, the training data for the identifier matching machine-learning model.

The online system 140 may receive (e.g., at the order management module 220), via the network from a device associated with the user (e.g., the user client device 100), information about an engagement by the user with a target identifier via a user interface of the device. The online system 140 may identify (e.g., via the identifier retrieval module 250) that the target identifier is unavailable at a source associated with the online system 140. Responsive to identifying that the target identifier is unavailable, the online system 140 may identify (e.g., via the identifier retrieval module 250), based at least in part on information about the target identifier, a set of candidate identifiers. The online system 140 may apply the identifier matching machine-learning model (e.g., via the identifier matching module 260) to the information about the target identifier and information about each candidate identifier from the set of candidate identifiers to output a matching score indicating the level of matching between the target identifier and each candidate identifier from the set of candidate identifiers. The online system 140 may select (e.g., via the identifier selection module 270), based on the matching score for each candidate identifier from the set of candidate identifiers, one or more identifiers from the set of candidate identifiers.

In one or more embodiments, the online system 140 receives (e.g., at the order management module 220), via the network from the device, information about an order that includes an item having the target identifier. In such cases, the online system 140 may update (e.g., via the content presentation module 210), based on the selected one or more identifiers, the user interface of the device to display information about one or more items having the selected one or more identifiers and one or more user interface elements that allow the user to convert the one or more items instead of the item having the target identifier.

The online system 140 may receive (e.g., at the machine-learning training module 230), from the device associated with the user and via the network, feedback data with information about an interaction by the user with the one or more items. The interaction may be a conversion of the one or more items, viewing details about the one or more items without conversion, ignoring presentation of the one or more items, etc. The online system 140 may re-train the identifier matching machine-learning model by updating (e.g., via the machine-learning training module 230), using the feedback data, the set of parameters of the identifier matching machine-learning model.

In one or more other embodiments, the online system 140 receives (e.g., at the order management module 220), via the network from the device, a search query entered by the user via the user interface of the device, the search query including a request for the target identifier. In such cases, the online system 140 may update (e.g., via the content presentation module 210), based on the selected one or more identifiers, the user interface of the device to display results of the search query that include information about a plurality of items having the selected one or more identifiers and a plurality of user interface elements each allowing the user to convert each of the plurality of items.

The online system 140 may retrieve (e.g., via the identifier retrieval module 250), from a database of the online system 140 (e.g., the data store 240), information about conversions by a group of users of the online system 140 in relation to a plurality of identifiers, the conversions occurring when one or more items having the target identifier are unavailable. The online system 140 may identify (e.g., via the identifier retrieval module 250), based at least in part on the information about the conversions, the set of candidate identifiers.

In one or more embodiments, the online system 140 generates (e.g., via the content presentation module 210), based at least in part on the selected one or more identifiers, a set of tags (e.g., keywords). In such cases, the online system 140 may communicate (e.g., via the content presentation module 210), via the network to a device of an entity associated with the online system 140 (e.g., computing system of CPG entity), the set of tags (e.g., keywords) for improving conversions of one or more items having the target identifier.

In one or more other embodiments, the online system 140 identifies (e.g., via the identifier selection module 270), based at least in part on the selected one or more identifiers, a set of one or more entities (e.g., one or more CPG entities) associated with the selected one or more identifiers. In such cases, the online system 140 may communicate (e.g., via the content presentation module 210), via the network to a device of an entity associated with the online system 140 (e.g., computing system of CPG entity), information about conversions of a first set of one or more items having the target identifier relative to conversions of a second set of one or more items having the selected one or more identifiers.

The online system 140 may compare (e.g., via the identifier selection module 270) matching scores for the set of candidate identifiers. The online system 140 may select (e.g., via the identifier selection module 270) an identifier from the set of candidate identifiers having the matching score that is a highest among the matching scores.

Embodiments of the present disclosure are directed to the online system 140 that trains a machine-learning model to score, for a given target identifier, a set of candidate identifiers (e.g., candidate brands) of items stored in a database of the online system 140, where each score represents a level of matching (or equivalency) of a corresponding candidate identifier to the target identifier.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, via a network from a first device associated with a first user of an online system, search data including information about a series of search queries entered by the first user via a user interface of the first device, the series of search queries including a series of identifiers for a set of items;
generating a search query label indicating matching of the series of identifiers;
receiving, via the network from a second device associated with a second user of the online system, conversion data including information about a search query entered by the second user via a user interface of the second device in relation to a first identifier of a first item that is followed by conversion by the second user of a second item having a second identifier different from the first identifier;
generating a conversion label indicating matching of the first identifier and the second identifier;
receiving, via the network from at least one of a device of a servicing agent associated with the online system or a third device associated with a third user of the online system, communication data exchanged between the device of the servicing agent and the third device with information about a message including a plurality of identifiers of a plurality of items;
generating a chat label indicating matching of the plurality of identifiers;
generating training data for an identifier matching machine-learning model of the online system by including in the training data a label comprising at least one of the search query label, the conversion label, or the chat label;
training, using the training data including the label, the identifier matching machine-learning model to generate a set of initial values for a set of parameters of the identifier matching machine-learning model, wherein the identifier matching machine-learning model is trained to identify a level of matching between an identifier searched for by a user of the online system via a user interface of a device associated with the user and a replacement identifier, the label representing a ground truth for the level of matching between the identifier and the replacement identifier; and
applying the identifier matching machine-learning model to information about the identifier and information about the replacement identifier to generate a matching score indicating the level of matching between the identifier and the replacement identifier that is indicative of whether the replacement identifier is a valid replacement for the identifier.

2. The method of claim 1, further comprising:
sending, via the network to a group of devices associated with a group of users of the online system, communications prompting each user from the group of users to select an alternative identifier to replace a target identifier requested by the group of users;
receiving, via the network from the group of devices, label data including information about a response from each user from the group of users about selection of the alternative identifier; and
generating, further based on the label data, the training data for the identifier matching machine-learning model.

3. The method of claim 1, further comprising:
receiving, via the network from a fourth device associated with a fourth user of the online system, replacement data including information about a conversion by the fourth user of a third item having a third identifier instead of a fourth item having a fourth identifier different from the third identifier, the fourth item being unavailable in a location of a source associated with the online system; and
generating, further based on the replacement data, the training data for the identifier matching machine-learning model.

4. The method of claim 1, further comprising:
receiving, via the network from a device associated with the user, information about an engagement by the user with a target identifier via a user interface of the device;
identifying that the target identifier is unavailable at a source associated with the online system;
responsive to identifying that the target identifier is unavailable, identifying, based at least in part on information about the target identifier, a set of candidate identifiers;
applying the identifier matching machine-learning model to the information about the target identifier and information about each candidate identifier from the set of candidate identifiers to generate a matching score indicating the level of matching between the target identifier and each candidate identifier from the set of candidate identifiers; and
selecting, based on the matching score for each candidate identifier from the set of candidate identifiers, one or more identifiers from the set of candidate identifiers.

5. The method of claim 4, wherein receiving the information about the engagement comprises:
receiving, via the network from the device, information about an order that includes an item having the target identifier, and the method further comprising:
updating, based on the selected one or more identifiers, the user interface of the device to display information about one or more items having the selected one or more identifiers and one or more user interface elements that allow the user to convert the one or more items instead of the item having the target identifier.

6. The method of claim 5, further comprising:
receiving, from the device associated with the user and via the network, feedback data with information about an interaction by the user with the one or more items; and
re-training the identifier matching machine-learning model by updating, using the feedback data, the set of parameters of the identifier matching machine-learning model.

7. The method of claim 4, wherein receiving the information about the engagement comprises:
receiving, via the network from the device, a search query entered by the user via the user interface of the device, the search query including a request for the target identifier, and the method further comprising:
updating, based on the selected one or more identifiers, the user interface of the device to display results of the search query that include information about a plurality of items having the selected one or more identifiers and a plurality of user interface elements each allowing the user to convert each of the plurality of items.

8. The method of claim 4, wherein identifying the set of candidate identifiers comprises:
retrieving, from a database of the online system, information about conversions by a group of users of the online system in relation to a plurality of identifiers, the conversions occurring when one or more items having the target identifier are unavailable; and
identifying, based at least in part on the information about the conversions, the set of candidate identifiers.

9. The method of claim 4, further comprising:
generating, based at least in part on the selected one or more identifiers, a set of tags; and
communicating, via the network to a device of an entity associated with the online system, the set of tags for improving conversions of one or more items having the target identifier.

10. The method of claim 4, further comprising:
identifying, based at least in part on the selected one or more identifiers, a set of one or more entities associated with the selected one or more identifiers; and
communicating, via the network to a device of an entity associated with the online system, information about conversions of a first set of one or more items having the target identifier relative to conversions of a second set of one or more items having the selected one or more identifiers.

11. The method of claim 4, wherein selecting the one or more identifiers comprises:
comparing matching scores for the set of candidate identifiers; and
selecting an identifier from the set of candidate identifiers having the matching score that is a highest among the matching scores.

12. A computer program product comprising a non-transitory computer readable storage medium having instructions encoded thereon that, when executed by a processor, cause the processor to perform steps comprising:
receiving, via a network from a first device associated with a first user of an online system, search data including information about a series of search queries entered by the first user via a user interface of the first device, the series of search queries including a series of identifiers for a set of items;
generating a search query label indicating matching of the series of identifiers;
receiving, via the network from a second device associated with a second user of the online system, conversion data including information about a search query entered by the second user via a user interface of the second device in relation to a first identifier of a first item that is followed by conversion by the second user of a second item having a second identifier different from the first identifier;
generating a conversion label indicating matching of the first identifier and the second identifier;
receiving, via the network from at least one of a device of a servicing agent associated with the online system or a third device associated with a third user of the online system, communication data exchanged between the device of the servicing agent and the third device with information about a message including a plurality of identifiers of a plurality of items;
generating a chat label indicating matching of the plurality of identifiers;
generating training data for an identifier matching machine-learning model of the online system by including in the training data a label comprising at least one of the search query label, the conversion label, or the chat label;
training, using the training data including the label, the identifier matching machine-learning model to generate a set of initial values for a set of parameters of the identifier matching machine-learning model, wherein the identifier matching machine-learning model is trained to identify a level of matching between an identifier searched for by a user of the online system via a user interface of a device associated with the user and a replacement identifier, the label representing a ground truth for the level of matching between the identifier and the replacement identifier; and
applying the identifier matching machine-learning model to information about the identifier and information about the replacement identifier to generate a matching score indicating the level of matching between the identifier and the replacement identifier that is indicative of whether the replacement identifier is a valid replacement for the identifier.

13. The computer program product of claim 12, wherein the instructions further cause the processor to perform steps comprising:
sending, via the network to a group of devices associated with a group of users of the online system, communications prompting each user from the group of users to select an alternative identifier to replace a target identifier requested by the group of users;
receiving, via the network from the group of devices, label data including information about a response from each user from the group of users about selection of the alternative identifier; and
generating, further based on the label data, the training data for the identifier matching machine-learning model.

14. The computer program product of claim 12, wherein the instructions further cause the processor to perform steps comprising:
receiving, via the network from a fourth device associated with a fourth user of the online system, replacement data including information about a conversion by the fourth user of a third item having a third identifier instead of a fourth item having a fourth identifier different from the third identifier, the fourth item being unavailable in a location of a source associated with the online system; and
generating, further based on the replacement data, the training data for the identifier matching machine-learning model.

15. The computer program product of claim 12, wherein the instructions further cause the processor to perform steps comprising:
receiving, via the network from a device associated with the user, information about an engagement by the user with a target identifier via a user interface of the device;
identifying that the target identifier is unavailable at a source associated with the online system;
responsive to identifying that the target identifier is unavailable, identifying, based at least in part on information about the target identifier, a set of candidate identifiers;
applying the identifier matching machine-learning model to the information about the target identifier and information about each candidate identifier from the set of candidate identifiers to generate a matching score indicating the level of matching between the target identifier and each candidate identifier from the set of candidate identifiers; and
selecting, based on the matching score for each candidate identifier from the set of candidate identifiers, one or more identifiers from the set of candidate identifiers.

16. The computer program product of claim 15, wherein the instructions further cause the processor to perform steps comprising:
receiving the information about the engagement by receiving, via the network from the device, information about an order that includes an item having the target identifier; and
updating, based on the selected one or more identifiers, the user interface of the device to display information about one or more items having the selected one or more identifiers and one or more user interface elements that allow the user to convert the one or more items instead of the item having the target identifier.

17. The computer program product of claim 16, wherein the instructions further cause the processor to perform steps comprising:
receiving, from the device associated with the user and via the network, feedback data with information about an interaction by the user with the one or more items; and
re-training the identifier matching machine-learning model by updating, using the feedback data, the set of parameters of the identifier matching machine-learning model.

18. The computer program product of claim 15, wherein the instructions further cause the processor to perform steps comprising:
receiving the information about the engagement by receiving, via the network from the device, a search query entered by the user via the user interface of the device, the search query including a request for the target identifier; and
updating, based on the selected one or more identifiers, the user interface of the device to display results of the search query that include information about a plurality of items having the selected one or more identifiers and a plurality of user interface elements each allowing the user to convert each of the plurality of items.

19. The computer program product of claim 15, wherein the instructions further cause the processor to perform steps comprising:
generating, based at least in part on the selected one or more identifiers, a set of tags;
communicating, via the network to a device of an entity associated with the online system, the set of tags for improving conversions of one or more items having the target identifier;
identifying, based at least in part on the selected one or more identifiers, a set of one or more entities associated with the selected one or more identifiers; and
communicating, via the network to the device of the entity, information about conversions of a first set of one or more items having the target identifier relative to conversions of a second set of one or more items having the selected one or more identifiers.

20. A computer system comprising:
a processor; and
a non-transitory computer-readable storage medium having instructions that, when executed by the processor, cause the computer system to perform steps comprising:
receiving, via a network from a first device associated with a first user of an online system, search data including information about a series of search queries entered by the first user via a user interface of the first device, the series of search queries including a series of identifiers for a set of items;
generating a search query label indicating matching of the series of identifiers;
receiving, via the network from a second device associated with a second user of the online system, conversion data including information about a search query entered by the second user via a user interface of the second device in relation to a first identifier of a first item that is followed by conversion by the second user of a second item having a second identifier different from the first identifier;
generating a conversion label indicating matching of the first identifier and the second identifier;
receiving, via the network from at least one of a device of a servicing agent associated with the online system or a third device associated with a third user of the online system, communication data exchanged between the device of the servicing agent and the third device with information about a message including a plurality of identifiers of a plurality of items;
generating a chat label indicating matching of the plurality of identifiers;
generating training data for an identifier matching machine-learning model of the online system by including in the training data a label comprising at least one of the search query label, the conversion label, or the chat label;
training, using the training data including the label, the identifier matching machine-learning model to generate a set of initial values for a set of parameters of the identifier matching machine-learning model, wherein the identifier matching machine-learning model is trained to identify a level of matching between an identifier searched for by a user of the online system via a user interface of a device associated with the user and a replacement identifier, the label representing a ground truth for the level of matching between the identifier and the replacement identifier; and
applying the identifier matching machine-learning model to information about the identifier and information about the replacement identifier to generate a matching score indicating the level of matching between the identifier and the replacement identifier that is indicative of whether the replacement identifier is a valid replacement for the identifier.
